(19) United States
(12) Patent Application Publication
(10) Pub. No.: US 2026/0020664 A1
(43) Pub. Date: Jan. 22, 2026

(54) AUTOMATIC CLEANING APPARATUS FOR SOLAR COLLECTORS, PHOTOVOLTAIC PANELS, WINDOWS AND SIMILAR SURFACES

(71) Applicant: UNIVERSIDAD TÉCNICA FEDERICO SANTA MARÍA, Valparaíso (CL)

(72) Inventors: Christian ORELLANA GÓMEZ, Viña del Mar (CL); Christian Pablo ROMERO VIEYRA, Casablanca (CL); Claudio Alejandro GONZÁLEZ FUENTES, Valparaíso (CL)

(21) Appl. No.: 18/997,789

(22) PCT Filed: Jul. 22, 2022
(86) PCT No.: PCT/CL2022/050071

§ 371 Date: Jan. 22, 2025

(51) Int. Cl. A46B 13/02; A46B 5/06; A46B 13/00; H02S 40/10

(52) U.S. Cl. CPC A46B 13/023; A46B 5/06; A46B 13/001; H02S 40/10; A46B 2200/3073

(57) ABSTRACT

Automatic cleaning apparatus for solar collectors, photovoltaic panels, windows and similar surfaces, consisting of an elastic brush 10 formed by an elastic cord 20 having bristles 30 inserted therein. The ends of the cord are hooked to discs 50 through hooks 40 that rotate through two motors 60 driven synchronously and controlled by a central unit 70. The cord vibrates and a circularly polarized stationary wave is established therein. The brush 10 is secured to a cart 80 that moves through wheels 90 driven by motors 100 across the photovoltaic panel.

### FIELD OF APPLICATION

The present invention refers to an apparatus for cleaning photovoltaic panels through waves generated by cords.

### DESCRIPTION OF PRIOR ART

The imminent climate change caused by the irrational use of fossil fuels has led non-conventional renewable energies (NCRE) to gain greater prominence in the protection of the environment. In recent decades, photovoltaic power has stood out among NCRCs due to the fall in its production costs. Today, hundreds of photovoltaic park projects are being installed around the world. However, to be competitive among NCRs, this technology needs to increase its efficiency in the conversion of light to electricity. The efficiency of photovoltaic panels (PVP) depends on various internal and external parameters, the latter including the temperature of the PVP and the accumulation of dust on its surface, called soiling. Soiling can reduce the efficiency of photovoltaic panels by 20%. The dust deposited on the surface of the PVP is linked to adhesion forces, which can be Van der Waals, electrostatic or hydrogen bonds forces. To remove this dust, it is necessary to count on removal forces that exceed the adhesion forces of the dust particles to the surface of the panel. An alternative is the washing of these surfaces with water and detergent, which involves long application times, high cost and is harmful to the environment, so efficient cleaning alternatives have been sought, from which two ways have been developed: passive and active. The latter has become increasingly important in reducing the problem of soiling, differing from the former basically in that it supplies energy in the cleaning process.

Among the cleaning systems, it is worth mentioning the electrostatic ones, which produce repulsion of the dust on the surface of the panel. This is achieved by applying electric fields that induce polarization in the dust particles deposited in the PVP, through a network of transparent electrodes integrated in the front glass of the PVP.

In addition, this method does not require moving parts for its operation and its energy requirement is very low compared to other cleaning methods. On the other hand, cleaning systems based on ultrasound have been developed, which through piezoelectric transducers located in the vicinity of the PVP generate pressure waves in the ultrasonic range which remove the dust deposited on the surface of the panel.

Moreover, there are robotic cleaning systems, widely used in large-scale dust removal. These electromechanical devices transfer an amount of linear motion (momentum) to the particles deposited on the surface of the panel through rigid shaft rotary brushes, by means of frictional force between the brush bristles and the surface of the panel. This removal force depends on the level of contact between the bristles and the surface, and the speed of rotation of the brushes. The brushes are attached to a wheeled frame that slides across the panel in horizontal and/or vertical direction. The brushes are rotated through motors by means of systems of gears and belts that also reduce the speed of rotation of the same. An electronic system controls the rotational speed of the brushes and the displacement of the system over the panel. In addition, they have a set of sensors to detect edges and a battery that is powered by a photovoltaic cell included in the robot.

Other associated solutions are also disclosed in prior art literature, for example, patent of invention U.S. Pat. No. 943,336B2 by MAZUMDER MALAY K, dated Sep. 6, 2016, entitled SELF-CLEANING SOLAR PANELS AND CONCENTRATORS WITH TRANSPARENT ELECTRODYNAMIC SCREEN, and patent application U.S. Pat. No. 20,120,285516A1 by MCKARRIS GEORGE application, dated Nov. 15, 2012, entitled INTELLIGENT & SELF-CLEANING SOLAR PANELS, propose the self-cleaning of panels through electrostatic repulsion using electrodes integrated to the panel. The disadvantage of these systems and devices lies mainly in the difficulty of removing dust particles of a certain size and the level of ambient humidity that also hinders dust removal.

Patent application U.S. Pat. No. 20,150,4768A1 by GHARIB MORTEZA and RINDERKNECT DEREK, dated Feb. 19, 2015. entitled METHODS AND SYSTEMIS FOR SELF-CLEANING OF PHOTOVOLTAC PANELS, proposes a PVP panel where translators are integrated into the panel. The disadvantage of this solution is the high cost of PVPs when integrating piezoelectrics and, in addition, they also present problems with removing dust of a certain size and the level of ambient humidity.

Patent of invention U.S. Pat. No. 9,192,966B2 by ZANATTA FRANCESCO, dated Nov. 24, 2015, entitled AUTOMATIC WASHING DEVICE FOR CONTINUOUS SURFACES, IN PARTICULAR SOLARTHERMAL COLLECTORS, PHOTOVOLTAIC PANELS, CONTINUOUS GLAZED BUILDING WALLS AND

SIMLAR SURFACES, and patent of invention U.S. Pat. No. 10,056,860B2 by WANG GUANYU, ZHANG JINGGONG ET AL., dated Aug. 21, 2018, entitled CLEANING MECHANISM HAVING SELF-LOCKING FUNCTION AND PHOTOVOLTAIC PANEL CLEANING EQUIPMENT HAVING SAME, propose the cleaning of panels using a rigid shaft rotary brush robot that can continuously clean rows of panels without having difficulty moving from one panel to another. A disadvantage of these systems is the slowness of the cleaning process due to the size of the brushes which limit their speed of rotation, thus requiring rigid bristles that are in full contact with the surface. The limitation of the speed of rotation of the brush is also necessary to reduce the vibrations of the panel and, in the process, to reduce energy consumption. For this reason, the robot must integrate speed reducers in the transmission of motion to the brush. When these systems are continuously used in the cleaning process, they can scratch the anti-reflective coating of the PVP glass, reducing its efficiency. In addition, many of these technologies require specialized personnel for their use and also the use of water for their operation.

Patent of invention U.S. Pat. No. 8,771,432B2 by MELLER MOSHE and MELLER ERAN, dated Jul. 8, 2014, entitled SOLAR PANEL CLEANING SYSTEM AND METHOD, corresponds to an autonomous robot that uses microfiber brushes to sweep dust from panels, it is designed for large rows of panels located in dry and sandy environments; the robot uses a photovoltaic panel and an on-board battery to store energy, which allows the robot to perform the cleaning at night and the placement of the photovoltaic panel that powers it at the bottom of the rail, allowing the robot itself to clean it. The disadvantage of this system, as in the previous ones, is the slowness of the cleaning process due, in part, to the limited speed of rotation of the microfiber brush and the composition of necessary movements, horizontal and vertical directions, which requires an intricate transmission system of rotational and translational movement of the brush. In addition, it requires the panels to be inclined at an angle greater than 30°.

None of the above-mentioned documents group desirable characteristics in the same cleaning system such as: continuous operation, speed in the cleaning process, energy efficiency, dry cleaning, decreased panel temperature. All this without the disadvantages of the systems described above in terms of cleaning dependency, dust size, ambient humidity, cleaning time and scratching of the anti-reflective coating of the panel.

### SUMMARY OF THE INVENTION

An autonomous apparatus for sweeping dust deposited on the surface of a photovoltaic panel (PVP) or similar is described, which comprises an elastic brush formed by an elastic cord having integrated filament bristles that protrude radially to the cross-section of the cord; wherein the ends of the elastic cord are attached through rolling hooks to discs that rotate by means of motors that support said discs and wherein the rolling hooks are attached to each end of the respective elastic cord to the edges of the discs in order to prevent continuous torsion of the elastic cord; and wherein the motors rotate synchronously producing stationary waves in the associated elastic brush; wherein the motors, which rotate synchronously producing stationary waves in the associated elastic brush, produce vibration modes of the elastic brush that are controlled by the rotational speed of the motors through a central processing unit; wherein the motors are arranged on a cart-type structure with wheels driven by two oppositely arranged motors that moves the structure across and over the surface of the PVP; and wherein the cart has an elastic brush, which is tensioned in a direction perpendicular to the movement of the cart.

### DESCRIPTION OF THE FIGURES

FIG. 1 illustrates a view of the components of the elastic brush of the cleaning apparatus of the invention.

FIG. 2 illustrates a rear view of the elastic brush of the cleaning apparatus of the invention.

FIG. 3 illustrates a rear view of the brush connected to the motors of the cleaning apparatus of the invention.

FIG. 4 illustrates a side view of the cleaning apparatus of the cleaning apparatus of the invention.

FIG. 5 illustrates a front view of the cleaning apparatus of the invention in operation.

FIG. 6 illustrates an isometric view of the cleaning apparatus of the invention in operation.

### GENERAL DESCRIPTION OF THE INVENTION

According to a first aspect, the present invention refers to an autonomous apparatus that sweeps the dust deposited on the surface of a photovoltaic panel (PVP), which is mainly constituted by a brush, formed by a tensioned elastic cord having integrated soft chenille-type bristles. The cord is vibrated through two synchronously rotating motors located at each of its ends, forming a circularly polarized stationary wave in the vicinity of the PVP surface. The polarization of the wave in the cord causes the rotation of the bristles, which in turn sweep the surface of the PFV, transferring the amount of movement (momentum) to the dust deposited on the surface. A structure with wheels holds the cord and moves it across the surface of the PVP.

Advantageously, the elastic cord is lighter than the rigid shaft brushes and to move it, it simply requires small motors that require less energy, facilitating continuous operation. On the other hand, the ability of the proposed apparatus to perform different sequences of modes and changes in the vibration plane, as well as a faster rotation of the bristles compared to rigid shaft brushes, favor the transfer of the amount of movement to the deposited dust. These filaments, being soft, do not put pressure on the PVP and can reduce scratching of the anti-reflective coating of the PVP. All this helps to improve cleaning performance without inducing significant vibrations on the PVP, resulting in reduced cleaning time.

### DETAILED DESCRIPTION OF A PREFERRED EMBODIMENT

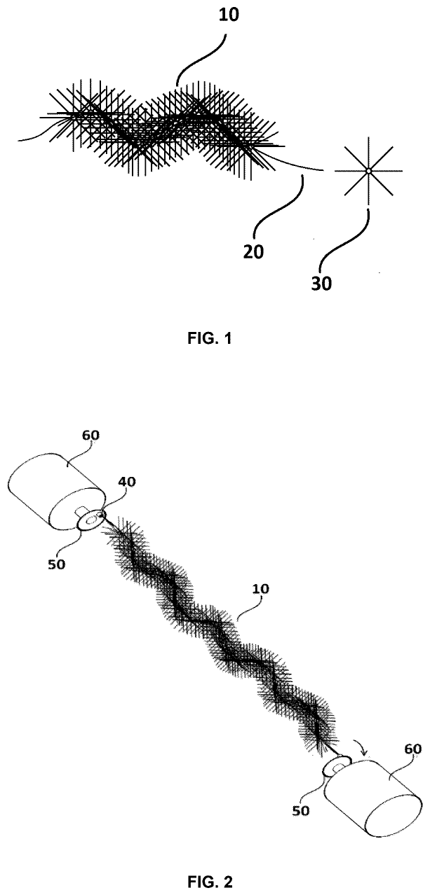

According to FIG. 1, the present invention is constituted basically by an elastic brush 10 formed by an elastic cord 20 having integrated filament bristles 30 that protrude radially to the cross section of the cord 20.

As can be seen in more detail in FIG. 2, the ends of the elastic cord 20 are attached through rolling hooks 40 to discs 50 that rotate by means of motors 60. These rolling hooks 40 are attached to each end of the respective cord to the edges of the discs 50 in order to prevent the continuous torsion of the elastic cords 20.

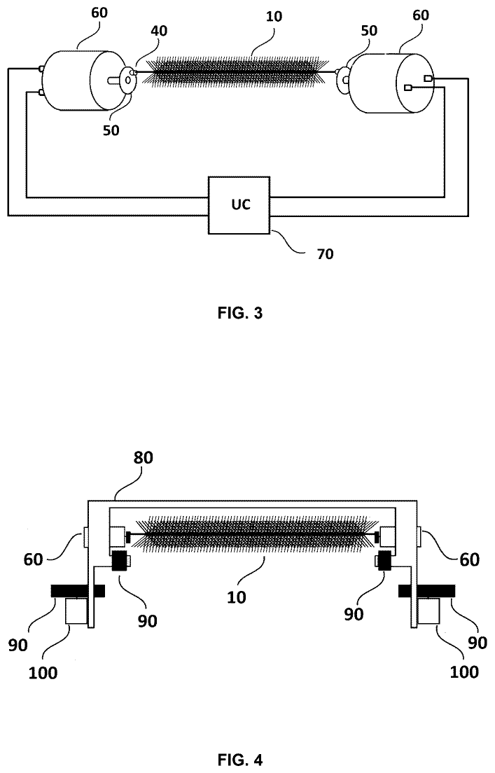

As shown in FIG. 3, the aforementioned motors 60 rotate synchronously producing stationary waves in the associated elastic brush 10. The vibration modes of the elastic brush 10 are controlled with the rotational speed of the motors 60 through a central process unit 70.

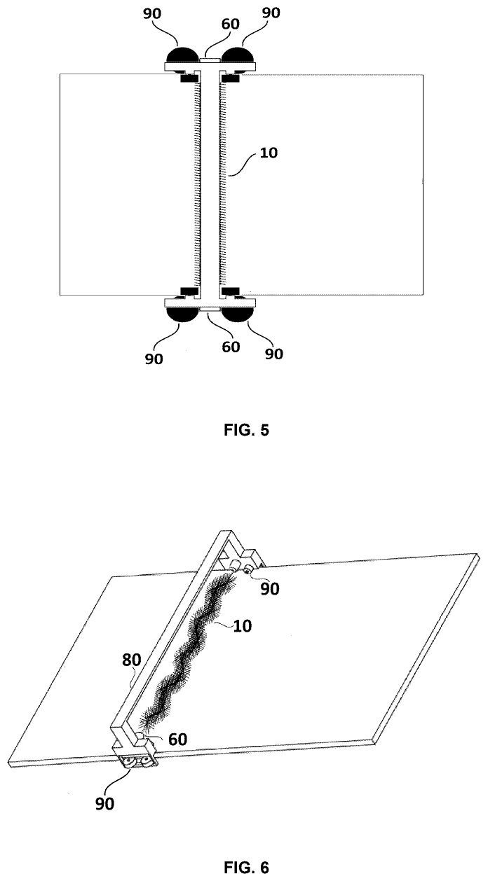

According to a preferred embodiment of the invention, and as illustrated in FIGS. 4, 5, and 6, a cart-type structure 80 with wheels 90 driven by two motors 100 that move the structure across and over the surface of the PVP is shown. An elastic brush 10 is arranged on the cart, which is tensioned in a direction perpendicular to the movement of the cart 80.

A second alternative embodiment of the invention, which is not shown, consists of two independent carts that move along the edges of the panel, where each one has a motor that holds between them an elastic brush 10. By means of this configuration, the cord can vibrate obliquely to the longitudinal direction of the panel, cleaning and preventing the precipitation atmospheric dust on said surface, as well as decreasing the temperature of the panel.

1. An autonomous apparatus for sweeping dust deposited on the surface of a photovoltaic panel (PVP) or similar, CHARACTERIZED in that it comprises an elastic brush 10 formed by an elastic cord 20 having integrated filament bristles 30 that protrude radially to the cross-section of the cord 20; wherein the ends of the elastic cord 20 are attached through rolling hooks 40 to discs 50 that rotate by means of motors 60 that support said discs 50, and wherein the rolling hooks 40 are attached at each end of the respective elastic cord 20 to the edges of the discs 50 in order to prevent continuous torsion of the elastic cord 20; and wherein the motors 60 rotate synchronously producing stationary waves in the associated elastic brush 10.

2. The autonomous apparatus according to claim 1, CHARACTERIZED in that the motors 60 that rotate synchronously producing stationary waves in the associated elastic brush 10 produce vibration modes of the elastic brush 10, which are controlled by the rotational speed of the motors 60 through a central process unit 70.

3. The autonomous apparatus according to claim 1, CHARACTERIZED in that the motors 60 are arranged on a cart-type structure 80 with wheels 90 driven by two motors 100 arranged oppositely that move the structure across and over the surface of the PVP: and wherein the cart 80 has an elastic brush 10, which is tensioned in a direction perpendicular to the movement of the cart 80.
